(19) United States
(12) Patent Application Publication
(10) Pub. No.: US 2015/0084287 A1
(43) Pub. Date: Mar. 26, 2015

(54) DUST COVER FOR BALL JOINT

(71) Applicant: NOK CORPORATION, Tokyo (JP)

(72) Inventor: Koji Kanagawa, Makinohara (JP)

(21) Appl. No.: 14/390,800

(22) PCT Filed: Sep. 19, 2013
(86) PCT No.: PCT/JP2013/075239

§ 371 Date: Oct. 6, 2014

(30) Foreign Application Priority Data
Oct. 12, 2012 (JP) 2012-226550

(51) Int. Cl. F16J 15/52

(52) U.S. Cl. CPC F16J 15/52
USPC 277/635

(57) ABSTRACT

In a rubber-like elastic dust cover for a ball joint structured such that a spherical head portion formed in one end of a ball stud is retained within a socket, a shaft portion in the other end of the ball stud is fastened and fixed to a knuckle, a one end large-diameter opening portion having a buried metal reinforcement ring is fixed and retained to an outer peripheral surface of the socket, and the other end small-diameter opening portion is retained to the shaft portion, and having a film portion which connects the one end large-diameter opening portion and the other end small-diameter opening portion, protrudes to an outer side and is formed approximately into a hand drum shape, a concave portion is provided in an outer peripheral surface of a joint portion between the one end large-diameter opening portion and the film portion.

### CROSS-REFERENCE TO RELATED APPLICATIONS

This application is a U.S. National Stage Application of International Application No. PCT/JP2013/075239 filed on Sep. 19, 2013, and published in Japanese as WO 2014/057779 A1 on Apr. 17, 2014. This application claims priority to Japanese Application No. 2012-226550 filed on Oct. 12, 2012. The entire disclosures of the above applications are incorporated herein by reference.

### TECHNICAL FIELD

The present invention relates to a dust cover for a ball joint.

Further, the present invention relates to a dust cover for a ball joint which is used in an automobile suspension device, and a steering device.

### DESCRIPTION OF THE CONVENTIONAL ART

Conventionally, as a ball joint to which a dust cover is installed for the purpose of a dust prevention and a water prevention in a ball joint coupling portion, there has been known a dust cover for a ball joint which is described in FIGS. 4 and 5 (Japanese Unexamined Patent Document No. 2009-24834 and Japanese Unexamined Patent Document No. 2001-323923).

In a seal structure of this kind of dust cover for the ball joint, a spherical head portion 200 formed in one end of a ball stud 100 is retained within a socket 300, as shown in FIGS. 4 and 5.

Further, a shaft portion 400 in the other end of the ball stud 100 is fastened and fixed to a knuckle 500.

On the other hand, a one end large-diameter opening portion 90 of a dust cover made of a rubber-like elastic material is fixed and retained to an outer peripheral surface of the socket 300 by a reinforcement ring 600 which is buried in the one end large-diameter opening portion 90 and is made of a metal material, and the other end small-diameter opening portion 70 is retained to the shaft portion 400.

Further, a film portion 800 is formed as a whole into a hand drum shape, the film portion 800 connecting the one end large-diameter opening portion 90 and the other end small-diameter opening portion 70.

The reinforcement ring 600 is constructed by a base portion 610, and a blade portion 620 which extends from the base portion 610 toward an outer peripheral surface of the socket 300.

Further, since the blade portion 620 eats into the outer peripheral surface of the socket 300, the dust cover is prevented from breaking away from the socket 300.

Therefore, the blade portion 620 is necessarily provided with a spring elasticity. On the other hand, the base portion 610 is necessarily provided with a sufficient rigidity to prevent a sealing performance from being lowered by deformation of the base portion 610 when the large-diameter opening portion 60 is pressed into the socket 300.

This kind of reinforcement ring 600 made of the metal material is manufactured by folding an outer peripheral side of an annular thin plate having a thickness Z, as shown in FIG. 5.

Accordingly, a width A in a diametrical direction of the base portion 610 is necessarily enlarged.

As a result, the film portion 800 in a compression side (a left side on the drawing) interferes with the one end large-diameter opening portion 90 as shown in FIG. 4, and a problem that the film portion 800 wears off and is damaged in an early stage has been brought about.

Further, in the case that the width A in the diametrical direction of the base portion 610 is sufficient, the base portion 610 can be pressed by a press fit jig P as shown in FIG. 6. Therefore, the dust cover can be installed to the socket 300 with no problem. However, in the case that protrusion toward an outer side in the diametrical direction of the one end large-diameter opening portion 90 is reduced for avoiding interference of the film portion 800 in the compression side with the one end large-diameter opening portion 90, the width A in the diametrical direction of the base portion 610 is necessarily narrowed. As a result, an area at which the base portion 610 can be pressed by the press fit jig P is reduced, and a problem that it is hard to push the one end larger-diameter opening portion 90 into the socket 300 has been caused.

In the same manner, in recent years, it has been strongly desired to make the ball joint compact, and the diameter of the socket 300 has been made as small as possible. As a result, a space for setting a step portion of the socket 300 has been restricted, the socket 300 to which the one end large-diameter opening portion 90 is installed.

As a result, the area at which the base portion 610 can be pressed by the press fit jig P has been reduced, and the problem that it is hard to press the one end large-diameter opening portion 90 to the socket 300 has been brought about.

### DISCLOSURE OF THE INVENTION

### Problem to be Solved by the Invention

The present invention is made by taking the problem mentioned above into consideration, and an object of the present invention is to provide a dust cover for a ball joint which can easily compress a one end large-diameter opening portion by a socket even if a width in a diametrical direction of a base portion of a reinforcement ring becomes narrow, the reinforcement ring being buried in the one end large-diameter opening portion and being made of a metal material, and even if a compact structure of the ball joint is progressed.

### Means for Solving the Problem

A dust cover for a ball joint according to the present invention is a dust cover for a ball joint structured such that a spherical head portion formed in one end of a ball stud is retained within a socket, a shaft portion in the other end of the ball stud is fastened and fixed to a knuckle, a one end large-diameter opening portion is fixed and retained to an outer peripheral surface of the socket, the one end large-diameter opening portion having a reinforcement ring made of a metal material and buried therein, and the other end small-diameter opening portion is retained to the shaft portion, having a film portion which connects the one end large-diameter opening portion and the other end small-diameter opening portion, and protrudes to an outer side and is formed approximately into a hand drum shape, and being made of a rubber-like elastic material, wherein a concave portion is provided in an outer peripheral surface of a joint portion between the one end large-diameter opening portion and the film portion.

### Effect of the Invention

The present invention achieves effects described below.

According to the dust cover for the ball joint of the invention described in the first aspect, the dust cover for the ball joint is structured such that the concave portion is provided in the outer peripheral surface of the joint portion between the one end large-diameter opening portion and the film portion. As a result, even if the width in the diametrical direction of the base portion of the reinforcement ring becomes narrow, the reinforcement ring being buried in the one end large-diameter opening portion and being made of the metal material, and even if the compact structure of the ball joint is progressed, the one end large-diameter opening portion can be easily compressed into the socket.

Further, according to a dust cover for a ball joint of the invention described in a second aspect, a plurality of concave portions are uniformly provided circumferentially. It is possible to inhibit the film portion from peculiarly deforming, and it is possible to minimize reduction of a strength of the film portion.

Further, according to a dust cover for a ball joint of the invention described in a third aspect, the dust cover for the ball joint is particularly effectively structured such that an outer diameter of the reinforcement ring made of the metal material is equal to or smaller than a maximum outer diameter of the film portion.

### BRIEF DESCRIPTION OF THE DRAWINGS

FIG. 1 is a vertical cross sectional view of a dust cover for a ball joint according to the present invention;

FIG. 2 is an enlarged view of a substantial part of the dust cover for the ball joint according to the present invention;

FIG. 3 is a vertical cross sectional view of a state of attaching a jig for installing the dust cover for the ball joint according to the present invention to a socket;

FIG. 4 is a vertical cross sectional view of a dust cover for a ball joint according to a prior art;

FIG. 5 is an enlarged view of a substantial part in FIG. 4; and

FIG. 6 is a vertical cross sectional view of a state of attaching a jig for installing the dust cover for the ball joint according to the prior art to the socket.

### MODE FOR CARRYING OUT THE INVENTION

A description will be given below of an embodiment for carrying out the present invention.

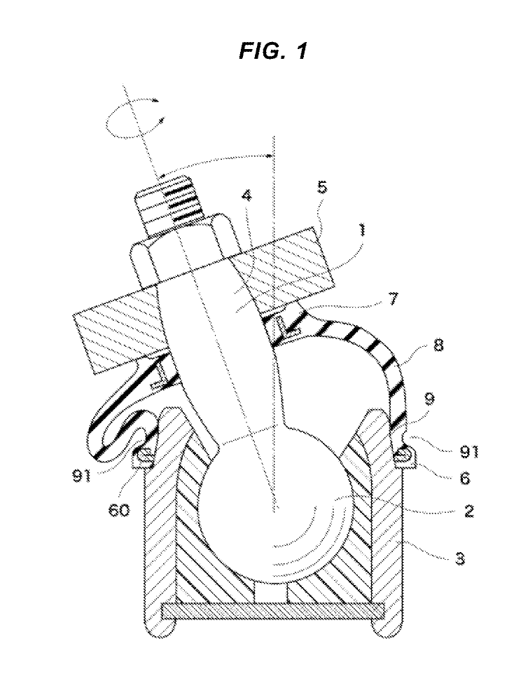

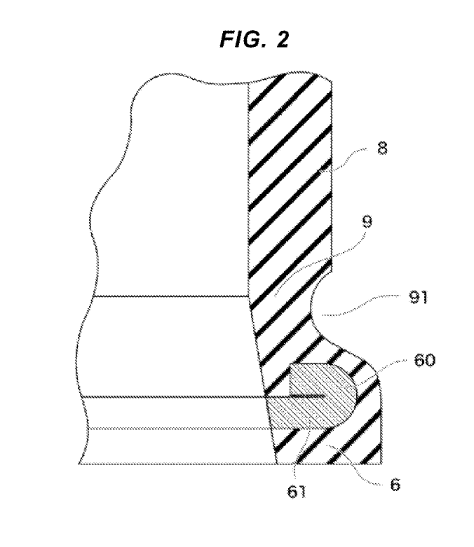

As shown in FIGS. 1 and 2, a dust cover for a ball joint according to the present invention is structured such that a spherical head portion 2 formed in one end of a ball stud 1 is retained within a socket 3, a shaft portion 4 in the other end of the ball stud 1 is fastened and fixed to a knuckle 5, a one end large-diameter opening portion 6 is fixed and retained to an outer peripheral surface of the socket 3, the one end large-diameter opening portion having a reinforcement ring 60 made of a metal material and buried therein, the other end small-diameter opening portion 7 is retained to the shaft portion 4, and a film portion 8 is provided for connecting the one end large-diameter opening portion 6 and the other end small-diameter opening portion 7, the film portion 8 protruding to an outer side and being formed approximately into a hand drum shape.

Further, a concave portion 91 is provided in an outer peripheral surface of a joint portion 9 between the one end large-diameter opening portion 6 and the film portion 8.

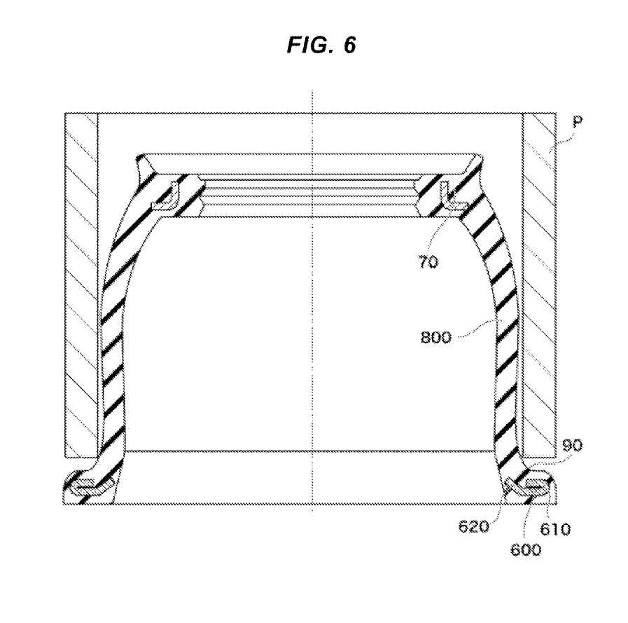

As mentioned above, since the concave portion 91 is provided, the one end large-diameter opening portion 7 can be easily compressed into the socket 3 even in the mode in which the width in the diametrical direction of the ball portion 61 of the reinforcement ring 60 becomes narrow, the reinforcement ring 6 being buried in the one end large-diameter opening portion 6 and being made of the metal material, and the mode in which the compact structure of the ball joint is progressed, which are hard to be installed by the conventional installation jig P as shown in FIG. 6.

The concave portion 91 may be formed into an annular shape, however, it is preferable that a plurality of concave portions 91 are uniformly provided circumferentially since it is possible to suppress peculiar deformation of the film portion 8 and it is possible to minimize reduction of the strength of the film portion 8.

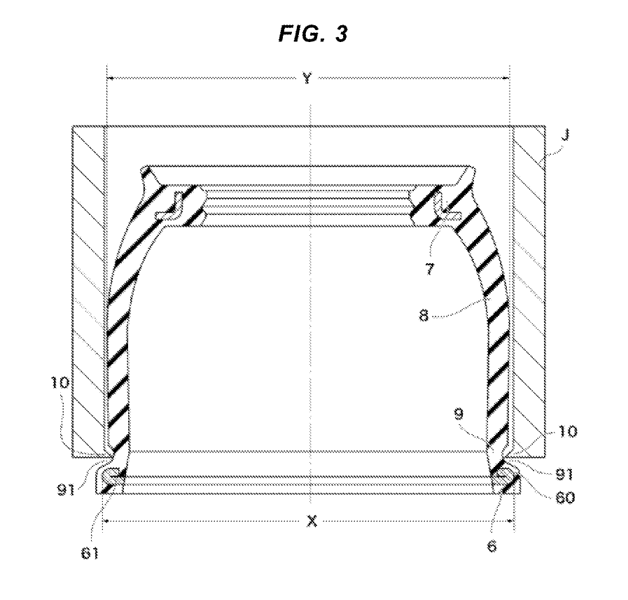

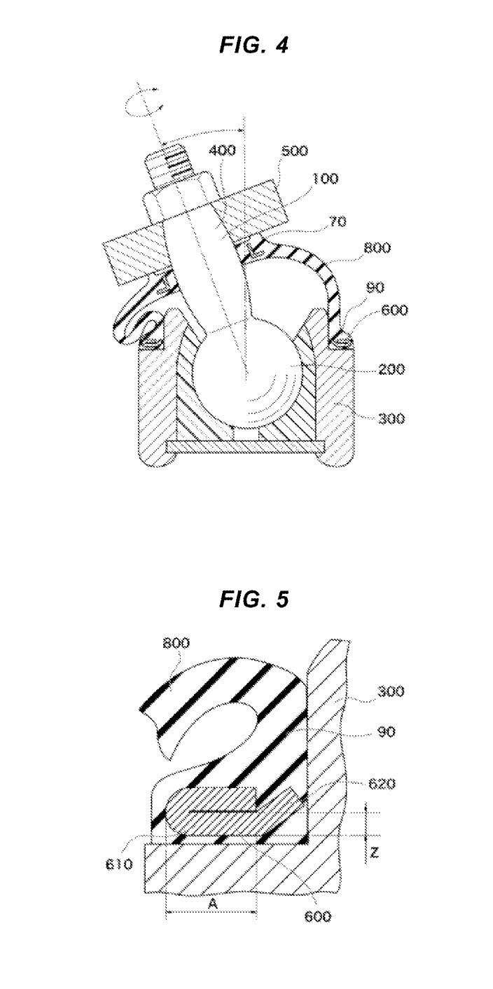

Further, in the case that the dust cover for the ball joint is installed to the socket 3, a compressing force of a split installation jig J can be transmitted to the base portion 61 of the reinforcement ring 60 made of the metal material via projections 10 and 10, by inserting the projections 10 and 10 into the concave portions 91 and 91, and thereafter compressing the installation jig J (moving downward in the drawing), the projections 10 and 10 being provided at leading ends of the jig J which is separated into a plurality of sections, and protruding inward in a diametrical direction, and the concave portions 91 and 91 being uniformly provided circumferentially, as shown in FIG. 3.

Therefore, even in the mode in which the width in the diametrical direction of the base portion 61 of the reinforcement ring 60 is narrowed as shown in FIG. 3, the one end large-diameter opening portion 6 can be easily compressed and installed to the socket 3.

Further, in the case that an outer diameter X of the reinforcement ring 60 made of the metal material is equal to or smaller than a maximum outer diameter Y of the film portion 8, the installation can not be achieved at all by the conventional installation jig P as shown in FIG. 6. Therefore, the mode according to the present invention is particularly effective, the mode being structured such that the concave portions 91 are provided in the outer peripheral surface of the joint portion 9 between the one end large-diameter opening portion 6 and the film portion 8.

Further, the reinforcement ring 60 can employ various modes which are manufactured by a sheet metal processing and a forging process.

Further, the dust cover is formed by various rubber-like elastic materials.

Since the reinforcement ring 60 can be made compact without taking an installation performance into consideration, it is possible to further reduce risk that the film portion 8 interferes with the one end large-diameter opening portion 6.

Further, it goes without saying that the present invention is not limited to the best mode for carrying out the invention mentioned above, but can employ the other various structures without deviating from the scope of the present invention.

### INDUSTRIAL APPLICABILITY

The present invention can be used in the ball joint which is used in the suspension device and the steering device of the motor vehicle.

1. A dust cover for a ball joint comprising:
a spherical head portion formed in one end of a ball stud, the spherical head portion being retained within a socket;
a shaft portion provided in the other end of said ball stud, the shaft being fastened and fixed to a knuckle;
a one end large-diameter opening portion fixed and retained to an outer peripheral surface of said socket, the one end large-diameter opening portion having a reinforcement ring made of a metal material and buried therein;
the other end small-diameter opening portion retained to said shaft portion;
a film portion connecting said one end large-diameter opening portion and said other end small-diameter opening portion, protruding to an outer side and formed approximately into a hand drum shape; and
the dust cover for the ball joint being made of a rubber-like elastic material,
wherein a concave portion is provided in an outer peripheral surface of a joint portion between said one end large-diameter opening portion and said film portion.

2. The dust cover for the ball joint according to claim 1, wherein a plurality of said concave portions are uniformly provided circumferentially.

3. The dust cover for the ball joint according to claim 1, wherein an outer diameter of said reinforcement ring made of the metal material is equal to or smaller than a maximum outer diameter of said film portion.

4. The dust cover for the ball joint according to claim 2, wherein an outer diameter of said reinforcement ring made of the metal material is equal to or smaller than a maximum outer diameter of said film portion.
